(19) United States
(12) Patent Application Publication
(10) Pub. No.: US 2005/0183243 A1
(43) Pub. Date: Aug. 25, 2005

(54) Fibrillation of natural fiber

(76) Inventor: Larry Charles Tinker, Corona, CA (US)

Correspondence Address: Lorraine M. Donaldson, 281 Sea Forest Court, Del Mar, CA, 92014, US

(21) Appl. No.: 10/888,499

(22) Filed: Jul. 12, 2004

Related U.S. Application Data
(60) Provisional application No. 60/487,696, filed on Jul. 13, 2003.

(51) Int. Cl. A01F 29/00; B02C 23/02; B02C 13/00; B02C 1/00; B02B 1/00; D01G 37/00; D01G 1/00

(52) U.S. Cl. 19/.35

(57) ABSTRACT

A process for the preparation of natural fibers for use in forming reinforced polymer composites. The process comprises fiberizing or fibrillating the natural fibers by introducing them to a hammermill that includes a rotor with hammers affixed, which uses hammers to force the material against a set of perforated screens. The size of the screen prevents the material from leaving the process until it is ground to the predetermined size.

This application claims the benefit of the Ser. No. 60/487,696 filed on Jul. 13, 2003, the complete disclosure of which is hereby incorporated by reference herein.

### BACKGROUND OF THE INVENTION

This invention relates generally to the preparation of natural fibers that can be used to reinforce a polymer composite. The present invention also relates, for example, to the use of a hammermill that forces the natural fiber material against a set of screens to fibrillate the fibers.

The use of flax or flax-like fibers in a thermoplastic resin is described in Great Britain Patent 2 090 849 A. That patent is incorporated herein in its entirety. However, there is a need for producing generally uniform natural fibers, which can be used in producing composite compositions. In satisfying this need, agricultural waste is converted into value-added reinforcement for plastics. Moreover, there is a need for producing reinforcement natural material that is lighter, cheaper, non-abrasive and recyclable.

Plastics are usually reinforced with fiberglass fiber, talc, mica or wood flour. However, fiberglass reinforcement is expensive, heavy, and difficult to recycle and is abrasive to machinery. Recently, there has been a resurgent interest in utilizing agricultural products as feedstock for industrial applications. In this fashion, dependence on forest products is reduced. In addition, natural resources are more sustainable and less toxic. For example, air pollution caused by burning straw is reduced. Furthermore, flax has demonstrated superior strength.

The present invention provides for manufacturing reinforcement material that is less expensive, lighter, recyclable and non-abrasive to machinery. Such reinforcement material can reinforce plastics with superior qualities to existing products.

### SUMMARY OF THE INVENTION

The present invention relates to a process for the preparation of natural fibers for use in forming reinforced polymer composites. The process comprises fiberizing or fibrillating the natural fibers by introducing them to a hammermill, which has hammers that have been affixed to a rotor, which uses the hammers to force the material against a set of perforated screens. The size of the screen prevents the material from leaving the process until it is ground to a predetermined size.

In a preferred embodiment of the invention, the process also includes removing the fiberized fiber from the hammermill and transporting it to a storage bin.

Thereafter the fiberized fiber can be metered and fed with additives into a final mix machine, which mixes the ingredients and heats them to form a soft dough, which can be granulated or pelletized. Either can be used with injection molding or extrusion devices. In an alternative preferred embodiment, the dough can be extruded into a final product.

### BRIEF DESCRIPTION OF THE DRAWINGS

Preferred features of the present invention are disclosed in the accompanying drawings, wherein similar reference characters denote similar elements throughout the several views, and wherein:

FIG. 1 is a flow diagram of the fibrillation process and the compounding process in accordance with the invention.

FIG. 2 illustrates an exemplary fiberizer system in accordance with an embodiment of the invention.

FIG. 32 illustrates an exemplary compounding system in accordance with an embodiment of the invention.

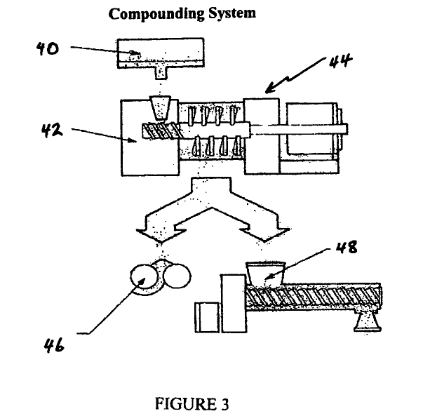

### DETAILED DESCRIPTION OF THE INVENTIONS

In the description which follows, any reference to direction or orientation is intended primarily and solely for purposes of illustration and is not intended in any way as a limitation to the scope of the present inventions. Also, the particular embodiments described herein, although being preferred, are not to be considered as limiting of the present inventions.

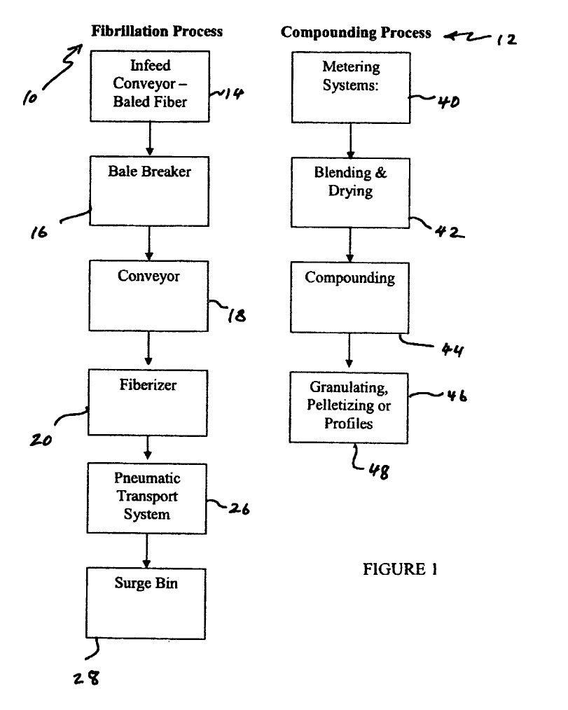

Referring to FIG. 1, an exemplary fibrillation process 10 and compounding process 12 in accordance with the present invention are shown. These processes provide for the fibrillation and compounding of natural fibers that can be used for reinforcing plastic or polymer composites.

In one exemplary preferred embodiment, the fibrillation process 10 provides for mechanically fibrillating or fiberizing natural fibers into individual fibers or fiber bundles. The process includes providing a natural fiber such as flax, hemp, kenaf, jute or other natural fiber products. Other fibers include oilseed and linen flax, sisal, ramie, sugar cane, bamboo, cotton, wheat straw, and coconut. Decortication is a mechanical process in which the bast fiber is separated from waste material, which is called shives. The fiber yield is dependent on many factors, including species, growing conditions and equipment efficiencies. In general the yield is 10% to 30%.

A compressed bale of fiber is conveyed on an infeed conveyor 14 to a bale breaking device 16 that breaks it up into loose fiber and meters it into the process as needed or desired. A conveyor 18 transports the fiber to a fiberizer system 20, preferably a hammermill, for further processing.

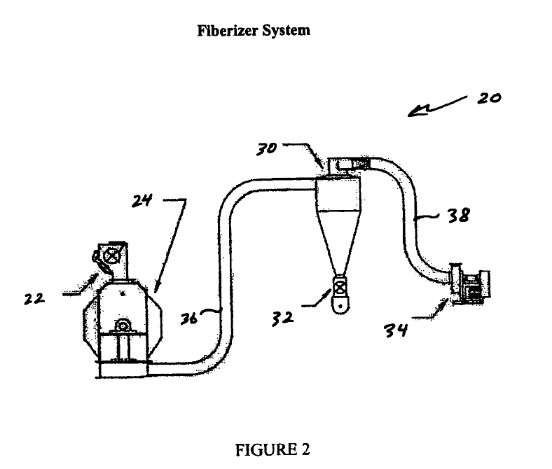

Referring to FIG. 2, the fiberizer system 20 includes a feeder 22 to the fiberizer/hammermill 24. The hammermill 24 functions as a fiberizer that includes a rotor, which uses hammers to force the material against a set of perforated screens. The mechanical action of the high-speed hammers breaks up the fiber bundles. The size of the screen prevents the material from leaving the process until it is ground to the proper size. A pneumatic air vacuum system removes the fiberized fiber from the hammermill and transports it to a surge bin 28 as shown in FIG. 1. The pneumatic air vacuum system, as shown in FIG. 2, includes an air system cyclone 30, an air system airlock 32 and a fan 34. A duct network provides for fluid communication among the various components of the fiberizer system 20. For example, duct 36, couples the fiberizer/hammermill 24 with the air system cyclone 30. Also, in the embodiment illustrated, duct 38 couples the air system cyclone 30 with the fan 34.

A surge bin 28 is used to store the processed fiber. The size is variable, but generally a 3 to 5 minute capacity is used. The goal of the bin 28 is to provide a generally constant flow to the compounding process 12.

Referring again to FIGS. 1 and 2, loss in weight feeders or volumetric feeders 40 are used to meter the proper amounts of additives needed for the final mix of material. Generally a separate metering system can be used for each material that is being added. For example, one for the polymer, one for fiber, one for additives.

The mix is discharged into the drying/blending machine 42 and compounding machine 44 as shown in FIG. 1. It mixes the ingredients together to form a consistent product and at the same time dries the fiber. The total mix is also preheated and discharged as a soft dough. As shown in FIG. 2, the blending/drying machine 42 and the compounding machine 44 can be integrated.

This compounded dough is then run as shown by the left flow arrow in FIG. 3 thru a granulator or pelletizer 46 to produce a powder/granulate. Alternatively, the compounded dough can be fed directly into an extruder 48 as shown in by the right flow arrow FIG. 3 that will produce pellets. The granules or pellets are the final product which can be sold to the injection molding or extrusion industries. In another embodiment of this invention, this aforementioned process step can also be eliminated and the dough can be extruded into a final product.

While hammermills have been used for years to reduce the size of all sorts of products, including wood and grain, this type is a precision machine that has been developed to meet a wide range of operating parameters. It operates as a fiberizer 24. It is believed that this is the first time a hammermill has been used successfully to break natural fiber into individual fiber bundles, and provide a generally uniform length to diameter ratio. This ratio is important in the polymer matrix, because it is what provides the reinforcing properties of the compounded polymer product.

In the operation of the hammermill 24 in the process of the present invention, various parameters or variables can be adjusted. These include: hammer thicknesses, hammer alloys, hammer speeds (rotational speed of the machine), screen perforation hole sizes, amount of open area of the screen, amount of closed area of the screen, type of perforation of the screen (holes, squares, slots), the pneumatic vacuum/air transport system is also another variable that can be adjusted. The amount of energy used is dependent on the size of the motor, the flow of material and the final size of the material being ground.

The use of the hammermill or fiberizer 24 of the present invention provides many advantageous. The adjustable variables allow the system to be fine tuned for various natural fibers and can also be adjusted to vary the final sizes of the product. Engineering of the machine allows for the ability to quickly change many of these variables. A preferred target is a 4 millimeter length of the fiber, which produces preferred maximum strength properties.

In an alternative emobodiment, the blending/drying system will now be further described. A preferred key component of the total process is to convert the fiberized fiber and a polymer into a compounded product. Typically the reinforcing material (fiber) would be metered into an extruder with the polymer and additives. The heat of the extruder and the resistance of the material moving through the extruder, creates more heat that melts the whole mix together into a matrix that is formed into a final product through a dye. This system is preferably unique in that a high speed blender is used, which uses high centrifugal forces to uniformly blend the fiber and polymer mix together. This total mix also melts into a dough like consistency. This is a batch type process that discharges into a continuous type granulating or pelletizing process.

If a typical or normal extruder is used to perform this mixing action, the friction can destroy the fiber length and the fiber may no longer be a reinforcing agent. The final result is that the fiber has become a filler with minimal strength properties.

The system variables that can be adjusted include: dwell time, RPM or speed of the rotation, temperature set points, motor load set points, variations in the recipe of input materials.

The advantages of this system include the following, The blending, because of the high speed equipment minimizes the damage to the fiber length. Therefore, the natural fiber has a short exposure period to the increased temperatures. Long periods of exposure to heat will cause the organic degradation of the strength properties. Hence the exposure is minimized. Moisture content of the fiber in the compounding process is very important or critical. This system also dries the fiber in the same process as the blending, so a separate dryer is not needed.

While the present invention has been described and illustrated herein with respect to the preferred embodiments thereof, it should be apparent that various modifications, adaptations and variations may be made utilizing the teachings of the present disclosure. It is intended that all these modifications are included within the scope of the claims without departing from the teachings of the present invention.

1. Process for the preparation of natural fibers for use in forming reinforced polymer composites comprising fiberizing or fibrillating the natural fibers by introducing them to a hammermill that includes a rotor with hammers affixed, and at least one screen, wherein said hammers force the natural fibers against said screen having a plurality of openings of a predetermined size and shape.
